(19) United States
(12) Patent Application Publication
(10) Pub. No.: US 2017/0060492 A1
(43) Pub. Date: Mar. 2, 2017

(54) ADAPTIVE POLLING OF PRINTERS THAT SERVICE SIMPLE NETWORK MANAGEMENT PROTOCOL REQUESTS

(71) Applicants: Gerald Donald Boldt, Longmont, CO (US); Gheorghe Cornel Bot, Lugoj (RO); Sorin Gheorghe Botan, Timisoara (RO)

(72) Inventors: Gerald Donald Boldt, Longmont, CO (US); Gheorghe Cornel Bot, Lugoj (RO); Sorin Gheorghe Botan, Timisoara (RO)

(73) Assignee: RICOH COMPANY, LTD., Tokyo (JP)

(21) Appl. No.: 14/836,306

(22) Filed: Aug. 26, 2015

(51) Int. Cl. G06F 3/12; H04L 12/26; H04L 12/24

(52) U.S. Cl. CPC G06F 3/1214; G06F 3/1229; G06F 3/1294; H04L 41/0213; H04L 43/10

(57) ABSTRACT

Embodiments described herein provide for adaptive polling of printers that service SNMP requests. One embodiment comprises a controller that identifies a group of pre-configured SNMP requests utilized for periodically polling a printer. The controller transmits a first SNMP request from the group to the printer in response to a start of the polling of the printer, and caches a SNMP response from the printer for the first SNMP request. The controller determines a response time of the printer for the first SNMP request, and determines if the response time exceeds a threshold. If the response time exceeds the threshold, then the controller halts transmission of remaining SNMP requests from the group to the printer. If the response time does not exceed the threshold, then the controller transmits the remaining SNMP requests to the printer, and caches SNMP responses from the printer for the remaining SNMP requests.

### FIELD

This disclosure relates to the field of printer management, and in particular, to printers that respond to Simple Network Management Protocol (SNMP) requests for information about the printer.

### BACKGROUND

SNMP is an application-layer protocol defined by the Internet Architecture Board (IAB) in Request For Comments (RFC) 1157 for exchanging management information between network devices. SNMP is part of the Transmission Control Protocol/Internet Protocol (TCP/IP) suite. SNMP is used in network management systems to monitor network-attached devices. SNMP exposes management data in the form of variables on the managed systems, which describe the system configuration. For instance, SNMP capable printers can respond to SNMP requests for information regarding the status of the printer.

Due to ongoing data processing that occurs at a printer during the printing process, responding to SNMP requests is often a secondary consideration. The result is that the printer may respond slowly to SNMP requests. When the printer responds slowly to SNMP requests, applications that rely on SNMP information from the printer can freeze or hang, which can cause problems for users of the applications.

### SUMMARY

Embodiments described herein provide for adaptive polling of printers that service SNMP requests. In adaptive polling, the number of SNMP requests sent to a printer changes when the printer is busy, which reduces the burden on the printer. Further, SNMP responses from the printer are cached, which allows for subsequent requests for information from the printer to utilize the cached data.

One embodiment comprises a controller that identifies a group of pre-configured SNMP requests utilized for periodically polling a printer. The controller transmits a first SNMP request from the group to the printer in response to a start of the polling of the printer, caches a SNMP response from the printer for the first SNMP request, and determines a response time of the printer for the first SNMP request. The controller determines if the response time exceeds a threshold. If the response time exceeds the threshold, then the controller halts transmission of the remaining SNMP requests from the group to the printer. If the response time does not exceed the threshold, then the controller transmits the remaining SNMP requests to the printer, and caches SNMP responses from the printer for the remaining SNMP requests.

Another embodiment comprises a method for adaptively polling printers that service SNMP requests. The method comprises identifying a group of pre-configured SNMP protocol requests utilized for periodically polling a printer, and transmitting a first SNMP request from the group to the printer in response to a start of the polling of the printer. The method further comprises caching a SNMP response from the printer to the first SNMP request, determining a response time of the printer to the first SNMP request, and determining if the response time exceeds a threshold. If the response time exceeds the threshold, then the method further comprises halting transmission of the remaining SNMP requests from the group to the printer. If the response time does not exceed the threshold, then the method further comprises transmitting the remaining SNMP requests to the printer, and caching SNMP responses from the printer for the remaining SNMP requests.

Another embodiment comprises a non-transitory computer readable medium comprising instructions which, when executed by a processor, direct the processor to identify a group of pre-configured SNMP requests utilized for periodically polling a printer. The instructions further direct the processor to transmit a first SNMP request from the group to the printer in response to a start of the polling of the printer, to cache a SNMP response from the printer for the first SNMP request, and to determine a response time of the printer for the first SNMP request. The instructions further direct the processor to determine if the response time exceeds the threshold. If the response time exceeds the threshold, then the instructions further direct the processor to halt transmission of the remaining SNMP requests from the group to the printer. If the response time does not exceed the threshold, then the instructions further direct the processor to transmit the remaining SNMP requests to the printer, and to cache SNMP responses from the printer for the remaining SNMP requests.

The above summary provides a basic understanding of some aspects of the specification. This summary is not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments are now described, by way of example only, and with reference to the accompanying drawings. The same reference number represents the same element or the same type of element on all drawings.

FIG. 1 is block diagram of a printing system in an exemplary embodiment.

FIG. 2 is a flow chart of a method for adaptively polling printers that service SNMP requests in an exemplary embodiment.

FIG. 3 is a flow chart of a method for intercepting status requests for a printer in an exemplary embodiment.

FIG. 4 illustrates a computing system in which a computer readable medium may provide instructions for performing any of the functionality disclosed herein for the controller of FIG. 1 in an exemplary embodiment.

### DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

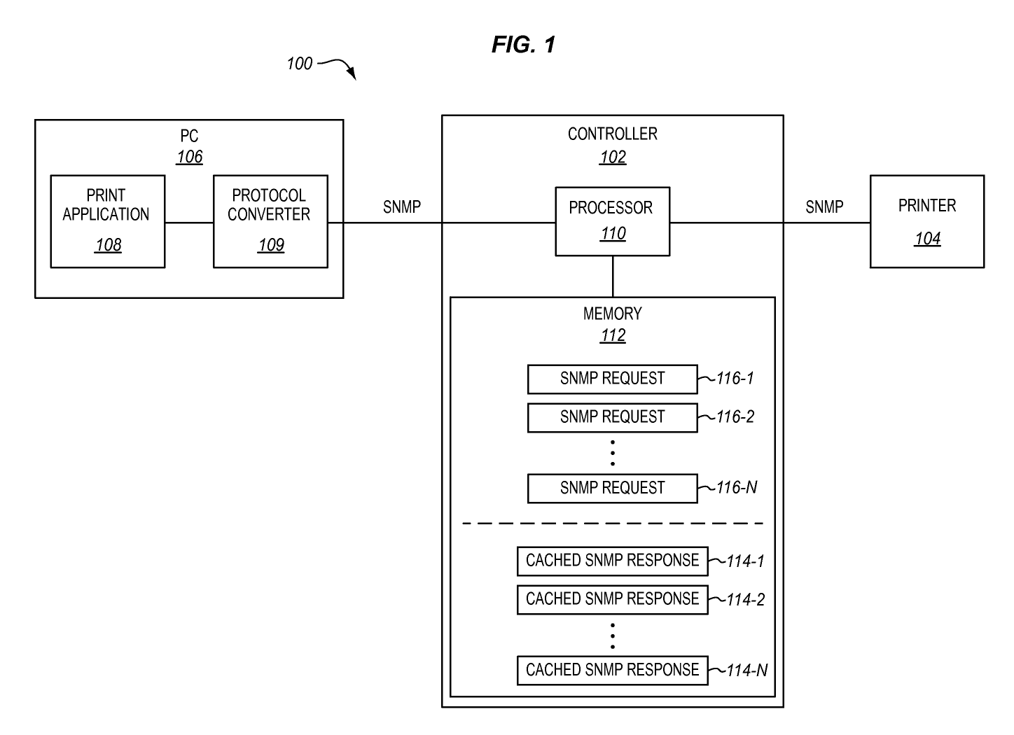

FIG. 1 is block diagram of a printing system 100 in an exemplary embodiment. In this embodiment, printing system 100 includes a controller 102. Controller 102 includes any component, system, or device that is able to adaptively poll printers that service SNMP requests, and to cache SNMP responses from printers. Printer 104 is able to generate a printed output based on print data. Printer 104 may comprise a continuous form printer, which generates a printed output onto a continuous web or roll of print media, such as paper. Printer 104 may also comprise a cut-sheet printer.

In this embodiment, print application 108 executes on a Personal Computer (PC) 106, and allows a user to control and monitor printer 104. For instance, print application 108 may provide an interface (not shown) to a user that enables the user to control and/or monitor the status of printer 104. Print application 108 may provide information to the user about the status of a paper tray at printer 104, the status of print jobs at printer 104, the status of errors that may exist at printer 104, etc. To provide information to the user, print application 108 utilizes SNMP information from printer 104. For example, print application 108 may generate status requests for printer 104 in Job Message Format (JMF), which is translated into one or more SNMP requests for printer 104 by protocol converter 109. If printer 104 is not busy, then the SNMP information from printer 104 may be obtained quickly (e.g., tens of milliseconds to a few seconds). This kind of timeliness in responding allows print application 108 to provide the information to the user quickly. For example, a user may utilize print application 108 to request a current status of a job printing at printer 104. In the example, print application 108 issues one or more status requests for information, which are converted into one or more SNMP requests for printer 104 by protocol converter 109. When a timely response by printer 104 occurs for the information, the user of print application 108 is provided the information quickly.

If printer 104 is busy, then problems may arise in servicing SNMP requests in a timely manner. For instance, if printer 104 is rasterizing jobs, then the complex data processing that occurs at printer 104 may not provide enough free processing capability to respond to the SNMP requests in a timely manner. In this case, printer 104 may respond very slowly to SNMP requests (e.g., some tens of seconds or possibly a few minutes). This lack of timeliness in responding prevents print application 108 from providing the information to the user quickly. For example, if the user utilizes print application 108 to request a current status of a job printing at printer 104, then the lack of a timely response from printer 104 to the one or more status requests to recover the status information may cause print application 108 to freeze, or otherwise be unable to provide the information to the user. This type of issue can be detrimental to the experience the user has while interacting with print application 108.

In this embodiment, controller 102 mitigates the problems associated with slow SNMP response times from printer 104 utilizing both an adaptive polling mechanism for printer 104 and a SNMP response caching mechanism for print application 108. The adaptive polling mechanism allows controller 102 to adjust the number of SNMP requests sent to printer 104 when printer 104 is busy. The SNMP caching mechanism allows controller 102 to intercept status requests sent by print application 108 for printer 104, and to respond to the status requests utilizing cached SNMP responses previously recovered from printer 104.

In this embodiment, controller 102 is illustrated separately from printer 104, print application 108, and protocol converter 109, but in other embodiments controller 102 and/or the functionality described herein for controller 102 may be part of PC 106, protocol converter 109, print application 108, and/or printer 104 as a matter of design choice. For instance, in one embodiment, controller 102 and/or the functionality described herein for controller 102 may be part of printer 104. In this embodiment, controller 102 may intercept network traffic at printer 104, and respond to SNMP requests received by printer 104 utilizing cached SNMP responses previously recovered from printer 104.

In another embodiment, controller 102 and/or the functionality described herein for controller 102 may communicatively couple a network interface of printer 104 to a network interface of PC 106. In this embodiment, controller 102 may intercept network traffic for printer 104, and respond to SNMP requests for printer 104 utilizing cached SNMP responses previously recovered from printer 104.

In another embodiment, controller 102 and/or the functionality described herein for controller 102 may operate as part of PC 106 as a software embodiment, a hardware embodiment, or a combination of both a software and hardware embodiment. In this embodiment, controller 102 may intercept network traffic destined for printer, and respond to SNMP requests for printer 104 utilizing cached SNMP responses from printer 104. In this embodiment, controller 102 may comprise a purely software embodiment, by operating (for example) as a SNMP trap service or application. In this purely software embodiment, the SNMP trap service or application intercepts SNMP requests for printer 104, and provides an adaptive polling and SNMP response caching capability.

While the specific hardware implementation of controller 102 is subject to design choices, one particular embodiment may include one or more processors 110 coupled with memory 112. Processor 110 includes any electronic circuits and/or optical circuits that are able to perform functions. For example, processor 110 may perform any functionality described herein for controller 102. Processor 110 may include one or more Central Processing Units (CPU), microprocessors, Digital Signal Processors (DSPs), Application-specific Integrated Circuits (ASICs), Programmable Logic Devices (PLD), control circuitry, etc. Some examples of processors include Intel® Core™ processors, Advanced Reduced Instruction Set Computing (RISC) Machines (ARM®) processors, etc.

Memory 112 includes any electronic circuits, and/or optical circuits, and/or magnetic circuits that are able to store data. For instance, memory 112 may be used to store pre-configured SNMP requests 116 for printer 104, which are periodically sent by controller 102 to printer 104 to recover information about printer 104. SNMP requests 116 may comprise some or all of the SNMP requests that may be generated by protocol converter 109 for printer 104. For example, SNMP requests 116 may comprise a query for a status of a paper tray of printer 104, a query for installed options at printer 104, a query for error conditions at printer 104, etc.

Memory 112 may also be used to store cached SNMP responses 114 from printer 104, which correspond to data recovered from printer 104 utilizing SNMP requests 116 transmitted to printer 104. For example, cached SNMP responses 114 may be a status of a paper tray of printer 104, the installed options at printer 104, error conditions at printer 104, etc. Memory 112 may include one or more volatile or non-volatile Dynamic Random Access Memory (DRAM) devices, FLASH devices, volatile or non-volatile Static RAM devices, magnetic disk drives, Solid State Disks (SSDs), etc. Some examples of non-volatile DRAM and SRAM include battery-backed DRAM and battery-backed SRAM.

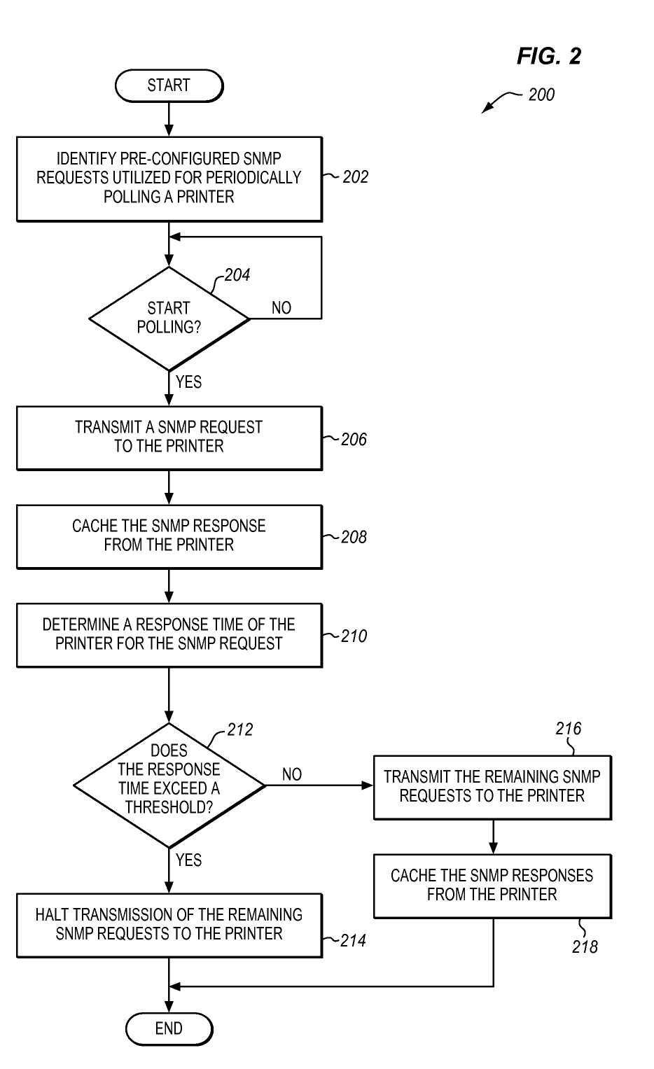

Consider that printing system 100 is operational and controller 102 is ready to begin a process of adaptive polling of printer 104 and caching of SNMP responses for printer 104. FIG. 2 is a flow chart of a method 200 for adaptively polling printers that service SNMP requests in an exemplary embodiment. Method 200 will be discussed with respect to printing system 100 of FIG. 1, although method 200 may be performed by other systems, not shown. The steps of the flow charts described herein may include other steps that are not shown. Also, the steps of the flow charts described herein may be performed in an alternate order.

Processor 110 of controller 102 identifies a group of pre-configured SNMP requests 116 stored in memory 112, which have been defined at controller 102 to correspond to a set of SNMP requests that printer 104 is capable of responding to (see step 202). For instance, if printer 104 is capable of recognizing and responding to fifteen distinct SNMP requests, then SNMP requests 116 stored in memory 112 may comprise fifteen entries of SNMP requests.

The SNMP protocol defines seven Protocol Data Unit (PDU) types, three of which are SNMP requests and one of which is a SNMP response. A SNMP GetRequest PDU is a message used to retrieve the value of a variable or a list of variables stored at printer 104. The desired variables are specified in variable bindings. A response from printer 104 to the GetRequestPDU is the value of the variable. A SNMP GetNextRequest is a message used to discover the available variables and their values stored at printer 104. The GetNextRequest can be used by controller 102 to walk through variables stored at printer 104 by repetitively transmitting SNMP GetNextRequest messages to printer 104. A SNMP GetBulkRequest message is an optimized version of the GetNextRequest message, and is used by controller 102 to request multiple iterations of GetNextRequest from printer 104. There are PDU specific non-repeaters and max-repetition fields in the GetBulkRequest message that are used to control how printer 104 responds to GetBulkRequest. A SNMP response from printer 104 returns variables to controller 102.

Processor 110 determines if a polling of printer 104 should start (step 204). Generally, polling of printer 104 starts periodically based on a polling interval. For instance, if the polling interval for printer 104 is two minutes, then processor 110 starts a polling process for printer 104 every two minutes. The polling interval is variable, and may be adjusted based on how often it is desired to update cached SNMP responses 114. Longer polling intervals reduce the processing required for printer 104 to respond to SNMP requests, but the result is that cached SNMP responses 114 are more “stale” since the cache may be updated less often.

If polling is to start, processor 110 transmits a SNMP request (e.g., SNMP request 116-1) to printer 104 (see step 206). The SNMP request may be, for example, a request that has been previously characterized by printing system 100 to determine how long it should take for printer 104 to respond when printer 104 is not busy. For instance, it may be previously characterized that printer 104 is capable of responding to SNMP request 116-1 within a few seconds when printer 104 is not busy, while printer 104 may respond more slowly to SNMP request 116-1 (e.g., tens of seconds or even minutes) when printer 104 is busy. Processor 110 caches the SNMP response (e.g., cached SNMP response 114-1) from printer 104 to the first SNMP request (see step 208). Caching the SNMP response from printer 104 can be used later by processor 110 to quickly respond to SNMP requests for printer 104.

Processor 110 determines the response time of printer 104 to the SNMP request (see step 210), and determines if the response time exceeds a threshold (see step 212). The threshold may be, for instance, ten seconds. If printer 104 takes longer than ten seconds to respond to the SNMP request, then this may indicate that printer 104 is busy. If printer 104 takes less than ten seconds, then this may indicate that printer 104 is not busy.

If the response time exceeds the threshold, then processor 110 halts transmission of the remaining SNMP requests 116 (e.g., SNMP requests 116-2 to 116-n) to printer 104 (see step 214). If the response time does not exceed the threshold, then processor 110 transmits the remaining SNMP requests 116 (e.g., SNMP requests 116-2 to 116-n) to printer 104 (see step 216), and caches the SNMP responses (e.g., cached SNMP response 114-2 to 114-n) from printer 104 (see step 218). Caching SNMP responses 114 from printer 104 can be used later by processor 110 to quickly respond to SNMP requests for printer 104.

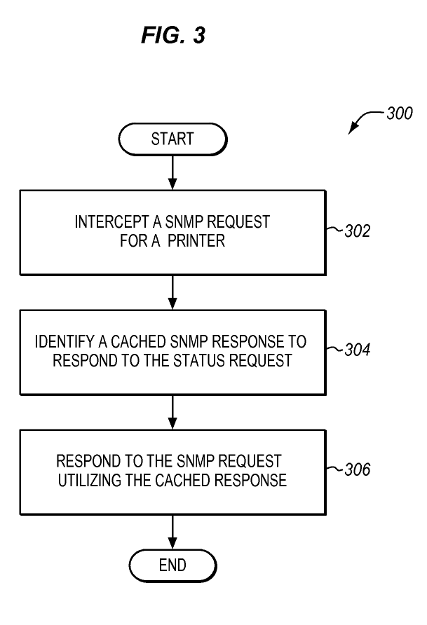

FIG. 3 is a flow chart of a method 300 for intercepting SNMP requests for a printer in an exemplary embodiment. Method 300 will be discussed with respect to printing system 100 of FIG. 1, although method 300 may be performed by other systems, not shown. Consider that print application 108 is generating status requests for printer 104. For example, print application 108 may be generating JMF formatted status requests, which are converted into one or more SNMP request for printer by protocol converter 109. Protocol converter 109 may the issue one or more SNMP request for printer 104 to respond to the JMF formatted status requests from print application 108. Processor 110 intercepts a SNMP request for printer 104 (see step 302). Processor 110 reviews the intercepted SNMP request and identifies a cached SNMP response 114 that corresponds to the SNMP request (see step 304). For instance, if the intercepted SNMP request corresponds to SNMP request 116-1, then a corresponding SNMP response may be cached SNMP response 114-1 stored in memory 112. Processor 110 responds to the SNMP request utilizing the cached SNMP response (see step 306). For example, processor 110 may transmit cached SNMP response 114-1 back to protocol converter 109, which then assembles a response to print application 108 for the JMF formatted status request.

Utilizing cached SNMP responses 114, processor 110 is able to quickly respond to SNMP requests for printer 104. This reduces or eliminates a delay that may occur when print application 108 requests information about printer 104. Print application 108 is no longer subject to freezing up or hanging up while waiting for the SNMP information about printer 104, which may take a while when printer 104 is busy. This improves the user experience when utilizing print application 108.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

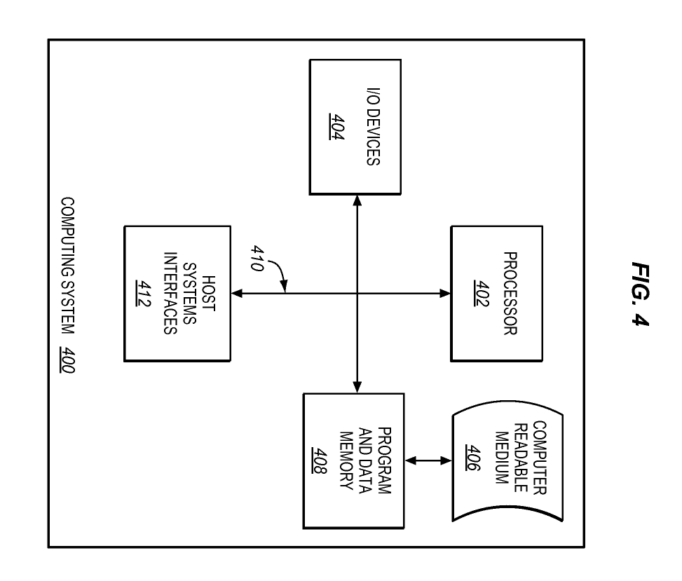

In one embodiment, the invention is implemented in software, which includes but is not limited to firmware, resident software, microcode, etc. FIG. 4 illustrates a computing system 400 in which a computer readable medium 406 may provide instructions for performing any of the functionality disclosed herein for controller 102.

Furthermore, the invention can take the form of a computer program product accessible from computer readable medium 406 that provides program code for use by or in connection with a processor or any instruction execution system. For the purposes of this description, computer readable medium 406 can be any apparatus that can tangibly store the program for use by or in connection with the instruction execution system, apparatus, or device, including computer system 400.

Computer readable medium 406 can be any tangible electronic, magnetic, optical, electromagnetic, infrared, or semiconductor system (or apparatus or device). Examples of computer readable medium 406 include a semiconductor or solid state memory, magnetic tape, a removable computer diskette, a random access memory (RAM), a read-only memory (ROM), a rigid magnetic disk and an optical disk. Some examples of optical disks include compact disk-read only memory (CD-ROM), compact disk-read/write (CD-R/W) and DVD.

Computing system 400, suitable for storing and/or executing program code, can include one or more processors 402 coupled directly or indirectly to memory 408 through a system bus 410. Memory 408 can include local memory employed during actual execution of the program code, bulk storage, and cache memories which provide temporary storage of at least some program code in order to reduce the number of times code is retrieved from bulk storage during execution. Input/output or I/O devices 404 (including but not limited to keyboards, displays, pointing devices, etc.) can be coupled to the system either directly or through intervening I/O controllers. Network adapters may also be coupled to the system to enable computing system 400 to become coupled to other data processing systems, such as through host systems interfaces 412, or remote printers or storage devices through intervening private or public networks. Modems, cable modem and Ethernet cards are just a few of the currently available types of network adapters.

Although specific embodiments were described herein, the scope is not limited to those specific embodiments. Rather, the scope is defined by the following claims and any equivalents thereof.

1. A system, comprising:
a controller configured to identify a group of pre-configured Simple Network Management Protocol (SNMP) requests utilized for periodically polling a printer, to transmit a first SNMP request from the group to the printer responsive to a start of the polling of the printer, and to cache a SNMP response from the printer for the first SNMP request;
the controller configured to determine a response time of the printer for the first SNMP request, and to determine if the response time exceeds a threshold;
the controller configured to halt transmission of remaining SNMP requests from the group to the printer responsive to determining that the response time exceeds the threshold;
the controller configured to transmit the remaining SNMP requests to the printer responsive to determining that the response time does not exceed the threshold, and to cache SNMP responses from the printer for the remaining SNMP requests;
the controller is configured to intercept a SNMP request for the printer, to identify a cached SNMP response for responding to the SNMP request, and to respond to the SNMP request utilizing the cached SNMP response without transmitting the SNMP request to the printer.

2. (canceled)

3. The system of claim 1 wherein:
the threshold is 10 seconds.

4. The system of claim 1 wherein:
one of the pre-configured SNMP requests comprises a query for a status of a paper tray of the printer.

5. The system of claim 1 wherein:
one of the pre-configured SNMP requests comprises a query for installed options at the printer.

6. The system of claim 1 wherein:
one of the SNMP requests comprises a query for error conditions at the printer.

7. A method, comprising:
identifying a group of pre-configured Simple Network Management Protocol (SNMP) requests utilized for periodically polling a printer;
transmitting a first SNMP request from the group to the printer responsive to a start of the polling of the printer;
caching a SNMP response from the printer for the first SNMP request;
determining a response time of the printer for the first SNMP request;
determining if the response time exceeds a threshold;
responsive to determining that the response time exceeds the threshold:
halting transmission of remaining SNMP requests from the group to the printer; and
responsive to determining that the response time does not exceed the threshold:
transmitting the remaining SNMP requests to the printer;
caching SNMP responses from the printer for the remaining SNMP requests; intercepting a SNMP request for the printer;
identifying a cached SNMP response for responding to the SNMP request and
responding to the SNMP request utilizing the cached SNMP response without transmitting the SNMP request to the printer.

8. (canceled)

9. The method of claim 7 wherein:
the threshold is 10 seconds.

10. The method of claim 7 wherein:
one of the pre-configured SNMP requests comprises a query for a status of a paper tray of the printer.

11. The method of claim 7 wherein:
one of the SNMP requests comprises a query for installed options at the printer.

12. The method of claim 7 wherein:
one of the SNMP requests comprises a query for error conditions at the printer.

13. A non-transitory computer readable medium comprising instructions which, when executed by a processor, direct the processor to:
identify a group of pre-configured Simple Network Management Protocol (SNMP) requests utilized for periodically polling a printer;
transmit a first SNMP request from the group to the printer responsive to a start of the polling of the printer;
cache a SNMP response from the printer for the first SNMP request;
determine a response time of the printer for the first SNMP request;
determine if the response time exceeds a threshold;
responsive to determining that the response time exceeds the threshold:
halt transmission of remaining SNMP requests from the group to the printer;
responsive to determining that the response time does not exceed the threshold:
transmit the remaining SNMP requests to the printer;
cache SNMP responses from the printer for the remaining SNMP requests;
intercept a SNMP request for the printer;
identify a cached SNMP response for responding to the SNMP request and
respond to the SNMP request utilizing the cached SNMP response without transmitting the SNMP request to the printer.

14. (canceled)

15. The non-transitory computer readable medium of claim 13 wherein:
the threshold is 10 seconds.

16. The non-transitory computer readable medium of claim 13 wherein:
one of the pre-configured SNMP requests comprises a query for a status of a paper tray of the printer.

17. The non-transitory computer readable medium of claim 13 wherein:
one of the pre-configured SNMP requests comprises a query for installed options at the printer.

18. The non-transitory computer readable medium of claim 13 wherein:
one of the pre-configured SNMP requests comprises a query for error conditions at the printer.
